(19) United States
(12) Patent Application Publication
(10) Pub. No.: US 2006/0153459 A1
(43) Pub. Date: Jul. 13, 2006

(54) Object classification method for a collision warning system

(76) Inventors: Yan Zhang, Kokomo, IN (US); Stephen J. Kiselewich, Carmel, IN (US)

Correspondence Address: DELPHI TECHNOLOGIES, INC., M/C 480-410-202, PO BOX 5052, TROY, MI, 48007, US

(21) Appl. No.: 11/032,629

(22) Filed: Jan. 10, 2005

(51) Int. Cl. G06K 9/00; G06K 9/62

(52) U.S. Cl. 382/224; 382/181; 382/104

(57) ABSTRACT

An object classification method for a collision warning system is disclosed. The method includes the steps of capturing a video frame with an imaging device and examining a radar-cued potential object location within the video frame, extracting orthogonal moment features from the potential object location, extracting Gabor filtered features from the potential object location, and classifying the potential object location into one of a first type of image or a second type of image in view of the extracted orthogonal moment features and the Gabor filtered features.

### FIELD OF THE INVENTION

The invention relates to object classification of images from an imaging device and more particularly to an object classification method for a collision warning system.

### BACKGROUND OF THE INVENTION

Collision warning has been an active research field due to the increasing complexities of on-road traffic. Generally, collision warning systems have included forward collision warning, blind spot warning, lane departure warning, intersection collision warning, and pedestrian detection. Radar-cued imaging devices for collision warning and mitigation (CWM) systems are of particular interest as they take advantage of both active and passive sensors. On one hand, the range and azimuth information provided by the radar can quickly detect the potential vehicle locations. On the other hand, the extensive information contained in the images can perform effective object classification.

Although prior art relating to the field of collision warning systems has demonstrated promising results, there is a need to improve object classification accuracy and system efficiency.

### BRIEF DESCRIPTION OF THE DRAWINGS

The present invention will now be described, by way of example, with reference to the accompanying drawings, in which:

FIG. 1A is a diagram of an object classification method for a collision warning system according to an embodiment;

FIG. 1B is a diagram of an object classification method for a collision warning system according to another embodiment;

FIG. 2 is a collision warning system image applicable to the method of FIGS. 1A and 1B;

FIG. 3 is a region of interest window of the collision warning system image according to FIG. 2;

FIG. 4 illustrates the principle of a support vector machine classifier;

FIGS. 5A-5D are examples of Gabor filters in the spatial domain;

FIG. 6A is a vehicle image taken from a region of interest window;

FIG. 6B is a Gabor-filtered vehicle image according to FIG. 6A;

FIG. 6C is a non-vehicle image taken from a region of interest window;

FIG. 6D is a Gabor-filtered non-vehicle image according to FIG. 6C;

FIGS. 7A and 7B are examples of classified vehicle images according to the method of FIGS. 1A and 1B; and

FIGS. 7C and 7D are examples of classified non-vehicle images according to the method of FIGS. 1A and 1B.

### DESCRIPTION OF THE PREFERRED EMBODIMENT

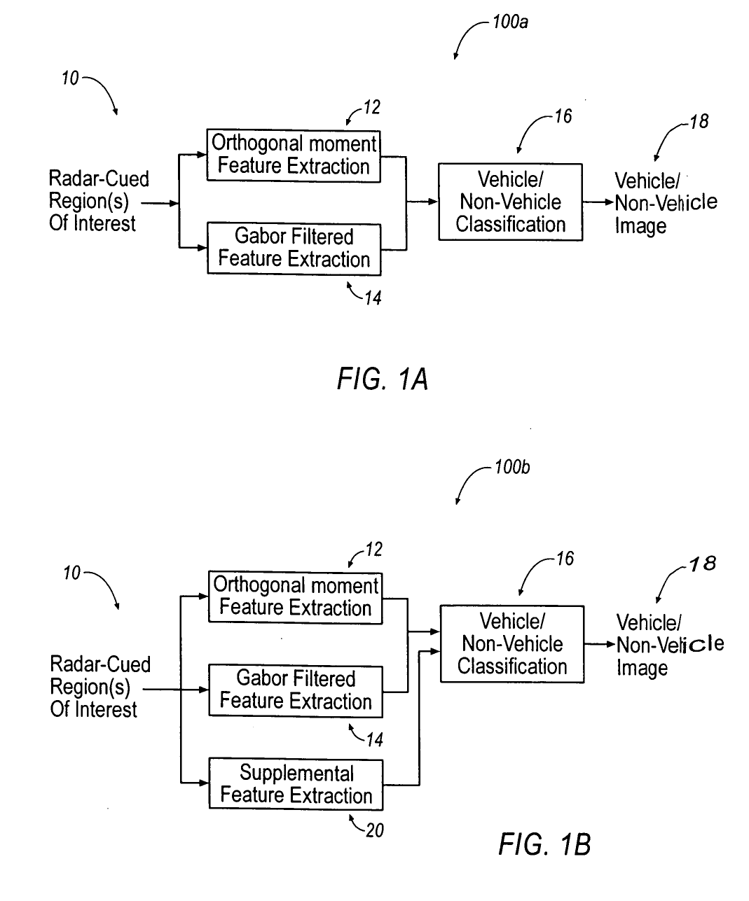

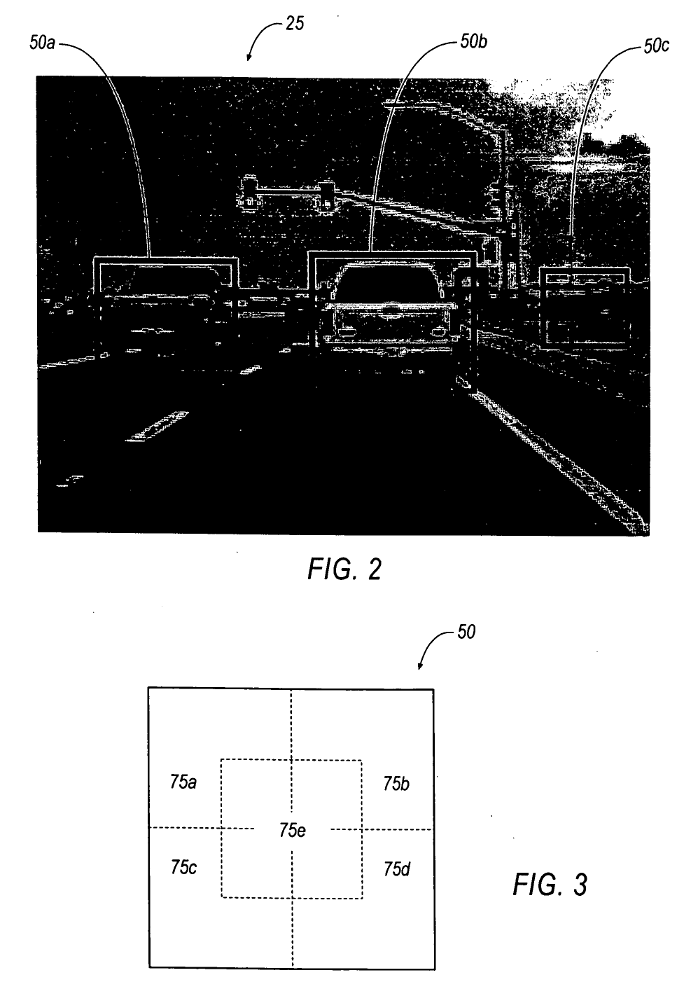

The disadvantages described above are overcome and a number of advantages are realized by an inventive object classification method for a collision warning system, which is shown generally at 100a and 100b in FIGS. 1A and 1B, respectively. Firstly, at step 10, an imaging device operates in conjunction with a radar to capture potential objects of interest from a video frame 25 (FIG. 2), As illustrated in FIG. 2, the video frame 25 includes potential objects of interest located in front of a host vehicle where the imaging device is mounted. Pixel features for the objects of interest are extracted by software algorithms at steps 12 and 14 to classify the objects of interest at step 16 into a classified image 18, which is used as an input for a collision warning system. Accordingly, the classified image 18 is input to the collision warning system as a first type of image, such as, for example, a vehicle image, and a second type of image, such as, for example, a non-vehicle image.

According to an embodiment, the imaging device may be a momochrome imaging device. More specifically, the imaging device may be any desirable camera, such as, for example, a charge-coupled-device (CCD) camera, a complementary metal oxide semiconductor (CMOS) camera, or the like. Referring to FIGS. 2 and 3, potential object of interest locations 50a-50c within the video frame 25 are hereinafter referred to as a region of interest (ROI) window 50. As illustrated in FIG. 3, the ROI window 50 may be sub-divided into two or more sub-regions, such as five sub-regions 75a-75e. By dividing the ROI window 50 into sub-regions, the software may look for specific features in a given sub-region to increase the efficiency of the software for discriminating vehicles from non-vehicles in the classification step 16. Although five sub-regions 75a-75e are illustrated in FIG. 3, it will be appreciated that the ROI window 50 may be sub-divided into any desirable number of sub-regions in any desirable pattern. For example, although FIG. 3 illustrates a central sub-region 75e and left, right, upper, and lower corner sub-regions 75a-75d, the ROI window 50 may be sub-divided into two regions, such as for example, an upper sub-region (i.e. 75a and 75b) and a lower sub-region (i.e. 75c and 75d). Alternatively, the ROI window 50 may be divided into a left-side sub-region (i.e. 75a and 75c) and a right-side sub-region (i.e. 75b and 75d).

At steps 12 and 14, the software extracts orthogonal moment features and Gabor filtered features from the ROI window 50. The features are referenced on a pixel-by-pixel basis of the image in the ROI window 50. Features from the orthogonal moments may be evaluated from the first order (i.e. mean), the second order (i.e. variance), the third order (i.e. skewness), the fourth order (i.e. kurtosis) and up to the 6^{th}-order. It will be appreciated that features from orders higher than the 6^{th} order may be extracted, however, as the order increases, the moments tend to represent the noise in the image, which may degrade overall performance of the feature extraction at step 12. As explained in the following description, features of the Gabor filtered images are extracted in two scales (i.e. resolution) and four directions (i.e. angle). However, it will be appreciated that any desirable number of scales and directions may be applied in an alternative embodiment.

At step 16, the extracted orthogonal moment and Gabor filtered features of the ROI window 50 are input to an image classifier, such as, for example, a support vector machine (SVM) or a neural network (NN), which determines if the image from the ROI window 50 is a vehicle image or a non-vehicle image 18. According to an embodiment, when the extracted orthogonal moment and Gabor filtered features are input to the classifier at step 16, both sets of features from steps 12 and 14 are concatenated in a merging of the feature coefficients.

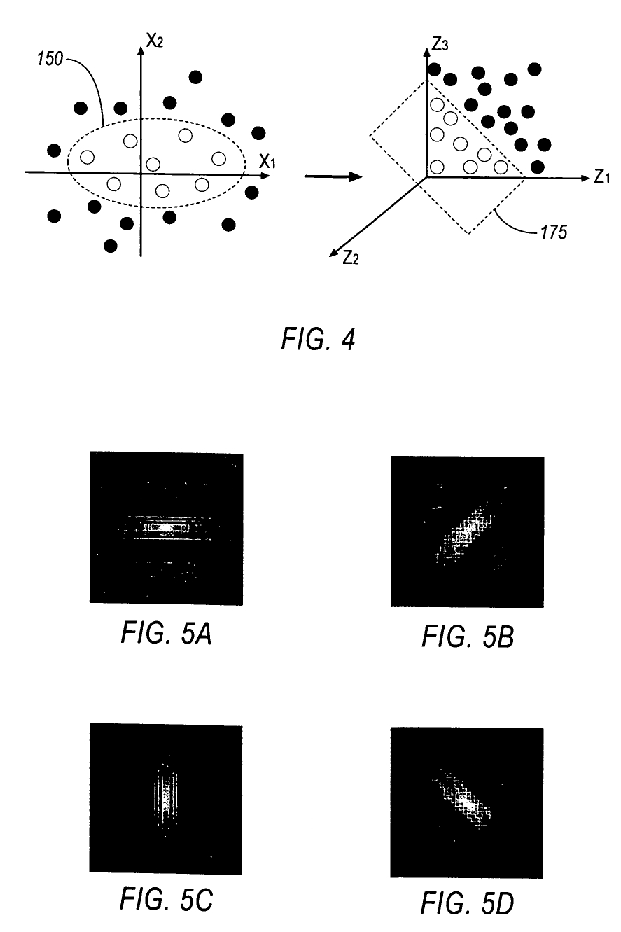

Referring to FIG. 4, an SVM classifier, as known in the art, turns a complicated nonlinear decision boundary 150 into a simpler linear hyperplane 175. The SVM shown in FIG. 4 operates on the principle where a monomial function maps image samples in the input two-dimensional feature space (i.e., x₁, x₂) to three dimensional feature space (i.e., z₁, z₂, z₃) via a mapping function (x₁², \sqrt{2}x₂x₂, x₂²). Accordingly, SVMs map training data in the input space nonlinearly into a higher-dimensional feature space via the mapping function to construct the separating hyperplane 175 with a maximum margin. The kernal function, K, integrates the mapping and the computation of the hyperplane 175 into one step, and avoids explicitly deriving the mapping function. Although different kernals lead to different learning machines, they tend to yield similar performance and largely overlapping support vectors. A Gaussian Radial Basis Function (RBF) kernal may be chosen due to its simple parameter selection and high performance.

As an alternative to the SVM, the NN classifier may be applied at step 16. The NN classifier is a standard feed-forward, fully interconnected back-propagation (FBNN) having hidden layers. It has been found that a fully-interconnected FBNN with carefully chosen control parameters provides the best performance. An FBNN generally consists of multiple layers, including an input layer, one or more hidden layers, and an output layer. Each layer consists of a varying number of individual neurons, where each neuron in any layer is connected to every neuron in the succeeding layer. Associated with each neuron is a function which is variously called an activation function or a transfer function. For a neuron in any layer but the output layer, this function is a nonlinear function which serves to limit the output of the neuron to a narrow range (i.e. typically 0 to 1 or −1 to 1). The function associated with a neuron in the output layer may be a nonlinear function of the type just described, or a linear function which allows the neuron to produce all values.

In an FBNN, there are three steps that occur during training. In the first step, a specific set of inputs are applied to the input layer, and the outputs from the activated neurons are propagated forward to the output layer. In the second step, the error at the output layer is calculated and a gradient descent method is used to propagate this error backward to each neuron in each of the hidden layers. In the final step, the propagated errors are used to re-compute the weights associated with the network connections in the first hidden layer and second hidden layer.

When applied to the method shown in FIGS. 1A and 1B, an NN according to an embodiment, may include two hidden layers having 90 processing elements in the first hidden layer and 45 processing elements in the second hidden layer. It will be appreciated that the number of processing elements in each hidden layer is best selected by a trial-and-error process and these numbers may vary. It will also be appreciated that NNs and SVMs represent two possible methods to be used for image classification in image classification at step 16 (e.g., decision trees, may be used in the alternative). If desired, the classification at step 16 may include more than one classifier, such as, for example, an NN and SVM. If multiple classifiers are arrayed in such a manner, an ROI window 50 input to the classification step 16 may be processed by each classifier to increase the probability of a correct classification of the object in the ROI window 50.

Referring back to FIGS. 1A and 1B, orthogonal moment feature extraction is preferred at step 12 in terms of information redundancy and representation abilities as compared to other types of moments. Orthogonal moments provide fundamental geometric properties such as area, centroid, moments of inertia, skewness, and kurtosis of a distribution. According to an embodiment of the invention, Legendre or Zernike orthogonal moment features may be extracted at step 12. In operation, orthogonal Legendre moments may be preferred over Zernike moments due to their favorable computational costs (i.e. computation time delay, amount of memory, speed of processor, etc.) and the comparable representation ability. More specifically, orthogonal Zernike moments have slightly less reconstruction error than orthogonal Legendre moments.

Legendre polynomials form a complete orthogonal basis set on the interval [−1,1]. The orthogonal Legendre moment features can be calculated in Equation 1 as follows, where ‘m’ and ‘n’ represent the order:

$${λ}_{mn} = \frac{( 2 m + 1 ) ( 2 n + 1 )}{{N}^{2}} {\sum }_{i = 0}^{N - 1} {\sum }_{j = 0}^{N - 1} {P}_{m} ( x ) {P}_{n} ( y ) f ( i , j ) . \qquad ( 1 )$$

Legendre moments are computed for the entire, original ROI window 50, or alternatively, for the sub-regions 75a-75e. When evaluated by the classifier in step 16, the 6^{th}-order orthogonal Legendre moment for the ROI window 50 includes 28 extracted moment values (i.e. 28 orthogonal Legendre features), whereas, when the ROI window 50 is sub-divided into five sub-regions 75a-75e, the classifier evaluates 140 extracted moment values (i.e. 28 features×5 sub-regions).

When image features are extracted in step 14, the Gabor filter acts as a local band-pass filter with certain optimal joint localization properties in both the spatial and the spatial frequency domain. A two-dimensional Gabor filter function is defined as a Gaussian function modulated by an oriented complex sinusoidal signal. More specifically, a two-dimensional Gabor filter g(x,y) is defined in Equation 2, where ‘x’ and ‘y’ represent direction, ‘σ’ represents scale, and ‘W’ represents cut-off frequency. The Fourier transform of Equation 2, G(u,v), is defined in Equation 3 as follows:

$$\begin{matrix}g ( x , y ) = \frac{1}{2 π {σ}_{x} {σ}_{y}} exp [ - \frac{1}{2} ( \frac{{x}^{′2}}{{σ}_{x}^{2}} + \frac{{y}^{′2}}{{σ}_{y}^{2}} ) ] exp [ j2 π {Wx}^{′} ] & ( 2 ) \\ G ( u , v ) = exp [ - \frac{1}{2} ( \frac{{( u - W )}^{2}}{{σ}_{u}^{2}} + \frac{{v}^{2}}{{σ}_{v}^{2}} ) ] . & ( 3 )\end{matrix}$$

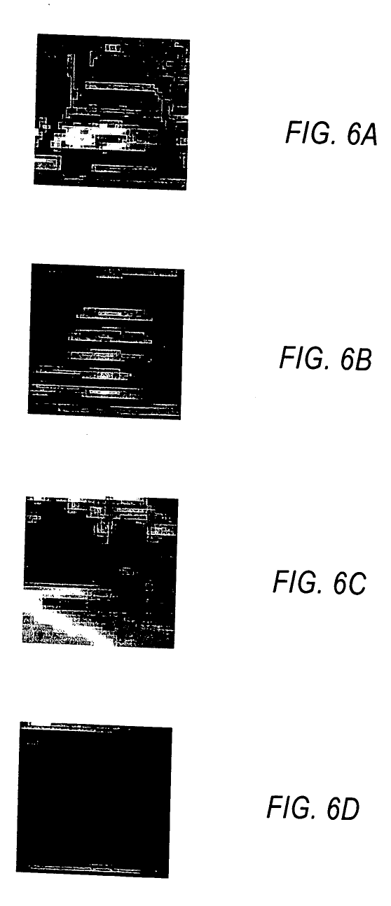

Referring to FIGS. 5A-5D, Gabor filters in the spatial domain are shown in 40×40 grayscale images. FIG. 5A has a 0° orientation, FIG. 5B has a 45° orientation, FIG. 5C has a 90° orientation, and FIG. 5D has a 135° orientation. If a multi-scale Gabor filter is provided, the Gabor filter may capture image characteristics in multiple resolutions. Accordingly, the method in FIGS. 1A and 1B apply a two-scale, three-by-three and six-by-six Gabor filter set. Additionally, the orientation of each Gabor filter described above helps discriminate ROI windows 50 that may or may not have horizontal and vertical parameters. For example, FIGS. 6B and 6D illustrate examples of Gabor filtered vehicle and non-vehicle images from FIGS. 6A and 6C, respectively, which provide a good representation of directional image details to distinguish vehicles from non-vehicles. Thus, the filtered vehicle image in FIG. 6B tends to have more horizontal and vertical features than the filtered non-vehicle image in FIG. 6D, which tends to have more diagonal image features.

According to an embodiment, the magnitude of the two-scale Gabor filtered ROI window 50 includes three types of texture metric features. The three types of texture metric features include mean, standard deviation, and skewness, which are calculated by the software. For a given 40×40 image, nine overlapping 20×20 sub-regions are obtained to provide a set of 216 Gabor features (i.e. two scales×four directions×three texture metrics×nine overlapping 20×20 sub-regions) for each ROI window 50.

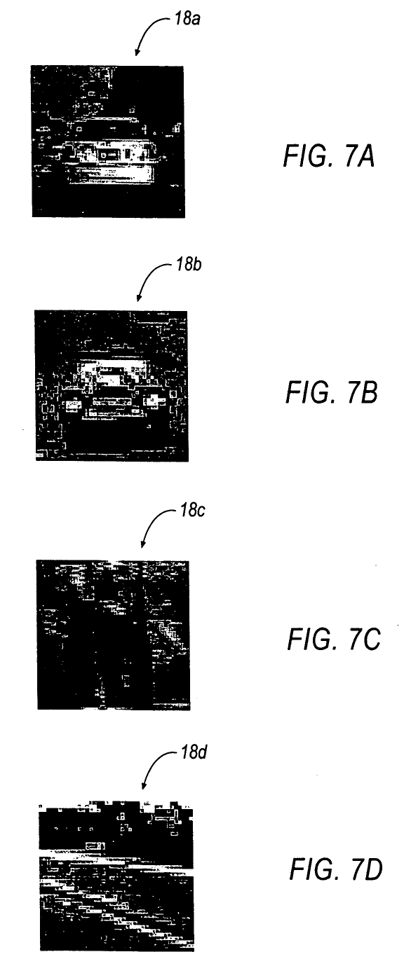

Referring to FIGS. 7A-7D, classified images 18a-18d of the method 100a are shown according to an embodiment. Classified vehicle images may include cars, small trucks, large trucks, and the like. Such classified vehicle images may encompass a wide range of vehicles in terms of size and color up to approximately seventy meters away under various weather conditions. Classified non-vehicle images, on the other hand, may include road signs, trees, vegetations, bridges, traffic lights, traffic barriers, and the like. As illustrated, the classified image 18a is a vehicle in daylight, the classified image 18b is a vehicle in the rain, the classified image 18c is a traffic light, and the classified image 18d is a traffic barrier.

For comparison in determining the most efficient analysis of the method as illustrated in 100a, orthogonal Legendre moments computed for the entire ROI 50 are referred to as “Legendre A Features,” and Legendre moments computed for the five sub-regions 75a-75e in an ROI window 50 are referred to as “Legendre B Features.” In the comparison, five data sets were tabulated. The data sets include Legendre A Features, Legendre B Features, Gabor Features, and a combination of the Legendre A Features with the Gabor Features and a combination of the Legendre B Features with the Gabor Features. The combination of Legendre and Gabor Features was carried out by a merging of the feature coefficients.

The offline testing sample data set consisted of 6482 images, which included 2269 for vehicles and 4213 for non-vehicles. The data was randomly split into 4500 images, approximately 69.4% of which was used for training and the remaining 1982 images of which were used for testing. To evaluate the classification performance, four metrics were defined to include (i) true positive (TP) as the probability of a vehicle classified as a vehicle, (ii) true negative (TN) as the probability of a non-vehicle classified as a non-vehicle, (iii) false positive/alarm (FP) as the probability of a non-vehicle classified as a vehicle, and (iv) false negative (FN) as the probability of a vehicle classified as a non-vehicle. These metrics are defined using the results of classifying the images from the test set. Table 1 summarizes the classification performances as follows:

TABLE 1

| Feature | TP (%) | TN (%) | FP (%) | FN (%) |
|---|---|---|---|---|
| Legendre A | 92.08 | 98.40 | 1.60 | 7.92 |
| Legendre B | 97.76 | 96.12 | 3.88 | 2.24 |
| Gabor | 93.12 | 98.78 | 1.22 | 6.88 |
| Legendre A | 99.10 | 98.10 | 1.90 | 0.90 |
| & Gabor | | | | |
| Legendre B | 97.16 | 99.62 | 0.38 | 2.84 |
| & Gabor | | | | |

As illustrated in Table 1, orthogonal Legendre B moments including the sub-regions 75a-75e yield significantly higher true positive (i.e., 97.76% vs. 92.08%) and slightly lower true negative (i.e., 96.12% vs. 98.4%) than orthogonal Legendre A moments, which includes only the ROI window 50 on its own without any sub-division of the window. Gabor features yield similar, but slightly better performance in comparison to the Legendre A features regarding all four metrics.

However, the merging of the Legendre moments and the Gabor features yields significantly better performance than either of the Legendre A, B, or Gabor features on its own. For instance, the merging of Gabor features and Legendre A moments yields the true positive as 99.1% and the true negative as 98.1%. The fusion of Gabor features and Legendre B moments shows a similar trend as the true positive of 97.16% and the true negative of 99.62%. Thus, a preferred embodiment may include a method that merges Gabor features with Legendre A moments (i.e, 28 features from a 40×40 image rather than 140 features from a 40×40 image) due to its high performance as indicated by the table and the smaller number of features in comparison to Legendre B feature (i.e. 140 features).

In alternative embodiment illustrated in FIG. 1B, a method 100b incorporating supplemental image feature extraction of the ROI window 50 at step 20 may be included as an input to the classifier at step 16. For example, supplemental feature extraction may include, but is not limited to, edge features and Haar wavelets. Haar wavelet features, for example, may be generated at four scales and three directions, which results in 2109 features extracted from a given ROI window 50.

Table 2 summarizes a similar testing procedure described above in which the classification performance comparison used Haar wavelets with an NN classifier. In this test, the proposed merging of the Legendre and Gabor features outperform the Haar wavelets. However, it will be appreciated that other supplemental image features from step 20, as an alternative to Haar wavelets, may return results that outperform the combination of the Legendre and Gabor features. Although not shown in the table, the supplemental feature extraction may also include a second set of orthogonal moment features, such as, for example, orthogonal Zernike moment features.

TABLE 2

| Feature | TP (%) | TN (%) | FP (%) | FN (%) |
|---|---|---|---|---|
| Legendre A | 94.90 | 99.28 | 0.72 | 5.10 |
| & Gabor | | | | |
| Legendre B | 95.81 | 99.39 | 0.61 | 4.19 |
| & Gabor | | | | |
| Haar | 93.68 | 98.49 | 1.51 | 6.32 |
| wavelets | | | | |

Thus, a merging of orthogonal Legendre moments and Gabor features show improved efficiency for vehicle recognition over conventional collision warning systems. The orthogonal Legendre moments may be computed globally from an entire ROI window 50, or locally from divided sub-regions 75a-75e while considering statistical texture metrics including the mean, the standard deviation, and the skewness from two scale and four direction Gabor filtered images. Moreover, alternative arrangements may be provided that permit the classifier to consider supplemental feature extraction in addition to the combination of the orthogonal Legendre features and Gabor features.

While the invention has been specifically described in connection with certain specific embodiments thereof, it is to be understood that this is by way of illustration and not of limitation, and the scope of the appended claims should be construed as broadly as the prior art will permit.

What is claimed is:

1. An object classification method comprising the steps of:
capturing a video frame with an imaging device and examining a radar-cued potential object location within the video frame;
extracting orthogonal moment features from the potential object location;
extracting Gabor filtered features from the potential object location; and
classifying the potential object location into one of a first type of image or a second type of image in view of the extracted orthogonal moment features and the Gabor filtered features.

2. The object classification method according to claim 1, wherein the classifying step is conducted in view of a merging of the extracted orthogonal moment features and the Gabor filtered features.

3. The object classification method according to claim 1, wherein the capturing step further comprising the step of sub-dividing the potential object location into more than one sub-region.

4. The object classification method according to claim 3, wherein the extracting orthogonal moment features step further comprises extracting orthogonal moment features from each of the one or more sub-regions.

5. The object classification method according to claim 1, wherein the orthogonal moment features are orthogonal Legendre moment features.

6. The object classification method according to claim 1, wherein the orthogonal moment features are orthogonal Zernike moment features.

7. The object classification method according to claim 1, wherein the Gabor filtered features are defined to include two scales/resolution and four directions defined by a 0°, a 45°, a 90°, and a 135°orientation.

8. The object classification method according to claim 7, wherein the Gabor filtered feature further comprises nine overlapping 20×20 pixel sub-regions and three texture metrics including mean, standard deviation, and skewness.

9. The object classification method according to claim 1, wherein the classifying step is conducted by a support vector machine or a neural network.

10. An object classification method for a collision warning system comprising the steps of:
capturing a video frame with an imaging device and examining a radar-cued potential object location within the video frame;
extracting orthogonal Legendre moment features from the potential object location;
extracting Gabor filtered features from the potential object location; and
classifying the potential object location into one of a vehicle image or a non-vehicle image in view of a merging of the extracted orthogonal Legendre moment features and the Gabor filtered features.

11. The object classification method according to claim 10, wherein the capturing step further comprising the step of sub-diving the potential object location into more than one sub-region.

12. The object classification method according to claim 11, wherein the extracting orthogonal Legendre moment features step further comprising extracting orthogonal Legendre moment features from each of the one or more sub-regions.

13. The object classification method according to claim 10, wherein the Gabor filtered features are defined to include two scales/resolution and four directions defined by a 0°, a 45°, a 90°, and a 135° orientation.

14. The object classification method according to claim 13, wherein the Gabor filtered feature further comprises nine overlapping 20×20 pixel sub-regions and three texture metrics including mean, standard deviation, and skewness.

15. The object classification method according to claim 10, wherein the classifying step is conducted by a support vector machine or a neural network.

16. An object classification method for a collision warning system comprising the steps of:
capturing a video frame with an imaging device and examining a radar-cued potential object location within the video frame;
extracting orthogonal Legendre moment features from the potential object location;
extracting Gabor filtered features from the potential object location;
extracting supplemental image features from the potential object location; and
classifying the potential object location into one of a vehicle image or a non-vehicle image in view of the extracted orthogonal Legendre moment features, the Gabor filtered features, and the supplemental image features.

17. The object classification method for a collision warning system according to claim 16, wherein the capturing step further comprising the step of sub-diving the potential object location into more than one sub-region.

18. The object classification method for a collision warning system according to claim 16, wherein the extracting orthogonal Legendre moment features step further comprising extracting orthogonal Legendre moment features from each of the one or more sub-regions.

19. The object classification method for a collision warning system according to claim 16, wherein the Gabor filtered features are defined to include two scales/resolution and four directions defined by a 0°, a 45°, a 90°, and a 135° orientation.

20. The object classification method for a collision warning system according to claim 19, wherein the Gabor filtered featured further comprises nine overlapping 20×20 pixel sub-regions and three texture metrics including mean, standard deviation, and skewness.

21. The object classification method for a collision warning system according to claim 16, wherein the classifying step is conducted by a support vector machine or a neural network.

22. The object classification method for a collision warning system according to claim 16, wherein the extracting supplemental image features from the potential object location step includes Haar wavelets and edge features.

23. The object classification method for a collision warning system according to claim 16, wherein the extracting supplemental image features from the potential object location step includes orthogonal Zernike moments.
